(19) United States
(12) Patent Application Publication
(10) Pub. No.: US 2025/0005281 A1
(43) Pub. Date: Jan. 2, 2025

(54) IMPROVING IMAGE QUALITY VIA DISCRETE NATURAL LANGUAGE TOKENS

(71) Applicant: International Business Machines Corporation, Armonk, NY (US)

(72) Inventors: Zhong Fang Yuan, Xi'an (CN); Si Tong Zhao, Beijing (CN); Yuan Yuan Ding, Shanghai (CN); Yi Chen Zhong, Shanghai (CN); Tong Liu, Xi'an (CN)

(21) Appl. No.: 18/344,481

(22) Filed: Jun. 29, 2023

(51) Int. Cl. G06F 40/284; G06F 40/30; G06T 11/00

(52) U.S. Cl. CPC G06F 40/284; G06F 40/30; G06T 11/00

(57) ABSTRACT

One or more systems, devices, computer program products and/or computer-implemented methods of use provided herein relate to generating images from sound waves using discrete natural language tokens as bridging features. The computer-implemented system can comprise a memory that can store computer executable components. The computer-implemented system can further comprise a processor that can execute the computer executable components stored in the memory, wherein the computer executable components can comprise an image generation component that can use a first neural network model to generate an image of an environment detected by an imaging sonar, based on discrete tokens in natural language that can represent sound waves reflected by structures in the environment, wherein the discrete tokens can be non-semantic.

### BACKGROUND

The subject disclosure relates to neural networks and, more specifically, to improving image quality via discrete natural language tokens.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable improving image quality via discrete natural language tokens are discussed.

According to an embodiment, a computer-implemented system is provided. The computer-implemented system can comprise a memory that can store computer-executable components. The computer-implemented system can further comprise a processor that can execute the computer-executable components stored in the memory, where the computer-executable components can comprise an image generation component that can use a first neural network model to generate an image of an environment detected by an imaging sonar, based on discrete tokens in natural language that can represent sound waves reflected by structures in the environment, where the discrete tokens can be non-semantic.

According to another embodiment, a computer-implemented method is provided. The computer-implemented method can comprise generating, by a system operatively coupled to processor, an image of an environment detected by an imaging sonar, based on discrete tokens in natural language that can represent sound waves reflected by structures in the environment, using a first neural network model, where the discrete tokens can be non-semantic.

According to yet another embodiment, a computer program product for improving a quality of images generated by an imaging sonar via discrete natural language tokens is provided. The computer program product can comprise a computer readable storage medium having program instructions embodied therewith, the program instructions executable by a processor to cause the processor to generate, by the processor, an image of an environment detected by the imaging sonar, based on discrete tokens in natural language that can represent sound waves reflected by structures in the environment, using a first neural network model, where the discrete tokens can be non-semantic.

### BRIEF DESCRIPTION OF THE DRAWINGS

FIG. 1 illustrates a block diagram of an example, non-limiting system that can use discrete natural language tokens to generate an image from sound waves in accordance with one or more embodiments described herein.

FIG. 2 illustrates a flow diagram of an example, non-limiting method that can generate an image of an object using sound waves reflected by the object in accordance with one or more embodiments described herein.

FIG. 3 illustrates an example, non-limiting representation of sonic input possibilities and image output possibilities for a neural network in accordance with one or more embodiments described herein.

FIG. 4 illustrates another example, non-limiting representation of sonic input possibilities and image output possibilities for a neural network in accordance with one or more embodiments described herein.

FIG. 5 illustrates flow diagrams of example, non-limiting methods that can generate an image of an object from discrete natural language tokens generated from sound waves in accordance with one or more embodiments described herein.

FIG. 6 illustrates flow diagrams for example, non-limiting images generated from discrete natural language tokens in accordance with one or more embodiments described herein.

FIG. 7 illustrates a flow diagram of an example, non-limiting method that can generate an image of an object from discrete natural language tokens using data augmentation in accordance with one or more embodiments described herein.

FIG. 8 illustrates a flow diagram of an example, non-limiting method for generating an image from sound waves using discrete natural language tokens in accordance with one or more embodiments described herein.

FIG. 9 illustrates a flow diagram of an example, non-limiting method that can use discrete natural language tokens to generate an image from sound waves in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In the deep sea, inside mining sites, inside of high-precision instruments and other invisible scenes, wherein visual capture features or light cannot be used for detection and wherein things are not visible to human eyes, acoustic waves are widely replied upon as a method for detection of objects, scenarios and/or environments with high precision and rich information load. However, since detected information is based on reflection of sound waves, the information can only be displayed on professional display devices, and displayed results are often not very conducive to human understanding. For example, signals captured by a sonar can be received in the form of a series number, a vector, or another format that can be interpreted a professional to understand and summarize the information contained in the signals. For example, seabed reefs scanned by a scanning sonar can be displayed as graphs, and the seabed reefs thus scanned can be difficult for non-professionals to identify. Imaging sonar technology can have a pre-set three-dimensional (3D) modeling library and relies on first knowing the type of object to be detected, followed by generating corresponding images through intensive calculation. Some other existing imaging sonar technologies (e.g., for shipwreck detection) also have limitations such as relatively expensive computational costs. Further, an imaging effect of an image generated by some existing technologies can depend on previous modeling which makes it difficult to further optimize the image. Using sonar technology can have additional limitations. For example, for usage in everyday/common scenarios (e.g., inspecting inner/hidden areas of a car), sonar technology can be expensive, and as stated above, sonar can need professional training to see, read and understand information from signals and features captured where common individuals or lay persons often do not have such training.

Thus, existing sound wave-to-image technologies have two challenges: high computational costs and difficulties for further image optimization. A solution for the two challenges can be based on analysis of respective causes of the problems. For example, the main reason for the problem of high computational cost is that most methods that can deliver good program performance use a sequence-to-sequence (seq2seq) method, which is the mutual mapping of high-dimensional sound feature vectors (input features) and high-dimensional image features (output features). For example, to build a neural network to build a mapping relationship between the input features and the output features, all neurons from a voice vector need to be mapped to image vectors, which can comprise a large amount of data while being expensive. More specifically, to simulate the mapping relationship using a neural network, a theoretically needed amount of parameters can be very large. For example, an amount of parameters needed for simulating the mapping relationship can be roughly estimated as M×N, wherein M is a data probability distribution value represented by a sound wave, and N is the data probability distribution value represented by an image to which the sound wave needs to be mapped. A neural network (e.g., a voice-to-image model) can generate an image from sound waves by learn mappings of numerous possibilities with parameters (e.g., N×M).

Similar considerations can apply to possibilities for training the neural network. For example, training the neural network can be based on supervised learning, and it is difficult to label the data to train the neural network since the process is often executed by professionals that label the data, store the data, transfer the data, etc. Gathering the data can also be difficult and using the data to enhance images via existing technologies can be an additional challenge. Further, the problem of the imaging effect being difficult to optimize occurs because the seq2seq method used in an image sonar needs to use end-to-end alignment data for annotation, wherein the end-to-end alignment data is difficult to collect, and using data augmentation methods to augment existing data can also be challenging. Data pairs needed for a seq2seq model are difficult to label. Thus, existing techniques for generating images from sound can lead to high computational costs and poor imaging effects. A solution to the above problems can comprise decomposing the one-way method (e.g., the overall seq2seq method of directly converting sound to an image) into a two-way method.

Various embodiments described herein can solve one or more of the above discussed problems by implementing a two-stage method for generating images from sound waves using discrete natural language tokens. Embodiments described herein include systems, computer-implemented methods, apparatus and computer program products that can use low computing resources and convert information (e.g., sound waves) returned by an imaging sonar into images that can be easily understood by humans. For example, various embodiments described herein can convert sound waves into discrete tokens in the form of natural language (i.e., discrete natural language tokens) by using a voice-to-text model. A sound transmitter of an imaging sonar can generate sound waves to detect an object. The object can reflect the sound waves back which can be processed by the voice-to-text model to generate the discrete tokens, wherein the discrete tokens can be non-semantic. The discrete tokens can be processed by a text-to-image model to generate an image of the object detected by the imaging sonar, wherein the object can comprise a single object, a scene or an environment (e.g., a stone, underwater scene, seabed reefs, etc.). Various embodiments described herein can use deconvolution, attention techniques, and heatmaps to discover respective contributions of individual tokens to local features of the image thus generated (e.g., discovering that a natural language token “feed” has made the greatest contribution to the generation of coral features in the image). Deconvolution is a technique used in image processing and computer vision to reconstruct an input image from feature representations of the input image. Attention techniques, such as self-attention or transformer models, can be used to selectively focus on relevant parts of input or feature maps, for improving a model's performance. Heatmaps, often generated using techniques like Grad-CAM, can highlight important regions of an image that can contribute to a model's decision, providing interpretability and insights into the model's behavior. Based on the respective contributions of the individual tokens, one or more of the individual tokens can be added, via token injection enhancement, to a token sequence corresponding to the image or another image to add one or more features to the image or the other image, wherein real data for the one or more features cannot be collected via sound waves. Token injection enhancement can include, but is not limited to, random scrambling, back translation, etc. A purpose of token injection enhancement is to generate a large amount of simulation data.

The various embodiments described herein can ensure that information contained in sound waves can be visualized in a form most easily understood by humans. The various embodiments described herein can aim for generating images that can generally resemble an actual object, scene or environment detected by an imaging sonar. For example, information returned in the form of a sound wave can be mapped to a reef with protruding edges on an ocean floor, and an image that can be restored using the various embodiments described herein can also comprise a reef with protruding edges. For example, the restored image can be generally similar to the real object, scene or environment and comprise the most important features of the real scene. For example, the reef and protruding edge features can be maintained in the image, such that a lay person can easily interpret the image. The image restored from the sound waves can be highly similar to the real scene without needing to be exactly the same as (e.g., 100 percent (%) similar to) the real scene, and the restored image can ensure that information contained in sound waves can be visualized in a form most easily understood by humans. Whereas traditional methods based on feature maps can have valuable features of the real scene, the image generated using the various embodiments described herein can be a restored map that can highlight valuable features of the real scene in a realistic manner.

Various embodiments described herein can solve problems of acoustic imaging in extreme environments by using a sound-to-language conversion method. Various embodiments described herein can use a detection sonar in invisible scenarios (e.g., deep sea) and convert sound waves received from a sound transmitter into discrete symbols (tokens) in natural language and use the discrete language symbols as bridging features. The discrete symbols can be non-semantic. Various embodiments described herein can use the sonar information for visual imaging for deep-sea exploration, explorations inside coal mining sites and exploration of other scenes that are not convenient for optical image acquisition. Various embodiments described herein can represent a feature transformer that can convert unreadable information to visible features that can be interpreted by the human eyes. It is to be appreciated that “discrete token(s),” “discrete natural language token(s),” “discrete language token(s),” etc. have been used interchangeably throughout this specification.

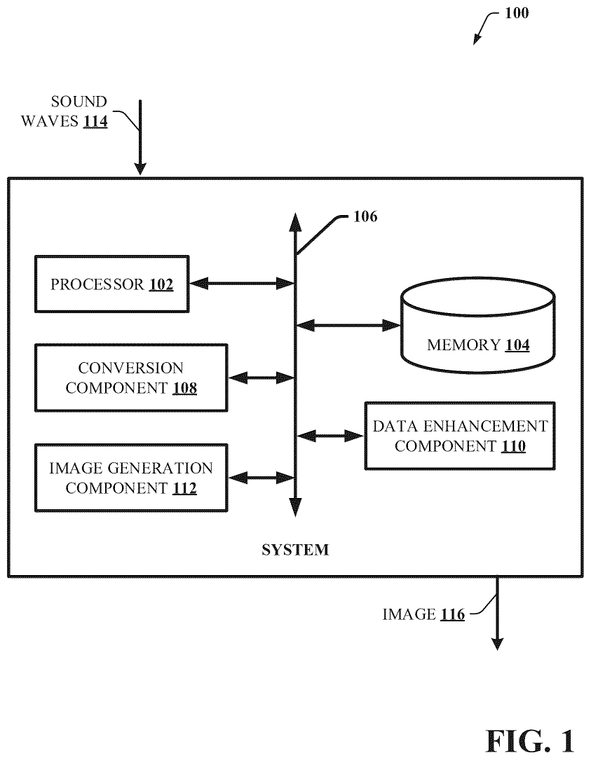

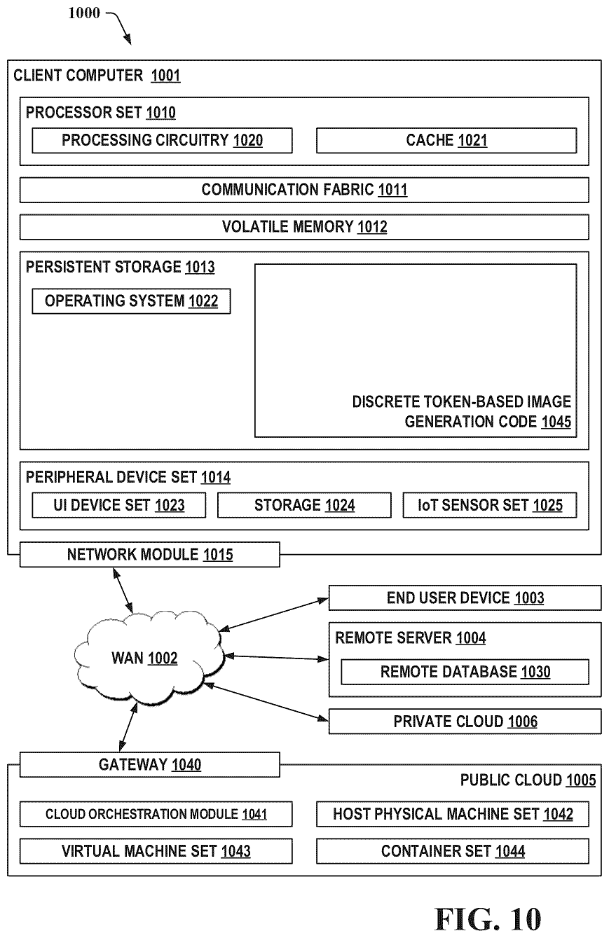

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. In one or more described embodiments, computer and/or computing-based elements can be used in connection with implementing one or more of the systems, devices, components and/or computer-implemented operations shown and/or described in connection with FIG. 10 and/or with other figures described herein.

FIG. 1 illustrates a block diagram of an example, non-limiting system 100 that can use discrete natural language tokens to generate an image from sound waves in accordance with one or more embodiments described herein. System 100 can comprise processor 102, memory 104, system bus 106, conversion component 108, data enhancement component 110, and image generation component 112.

The system 100 and/or the components of the system 100 can be employed to use hardware and/or software to solve problems that are highly technical in nature (e.g., related to neural networks, image generation by an imaging sonar, etc.), that are not abstract and that cannot be performed as a set of mental acts by a human. Further, some of the processes performed may be performed by specialized computers for carrying out defined tasks related to generating images from discrete natural language tokens based on sound waves. The system 100 and/or components of the system can be employed to solve new problems that arise through advancements in technology, computer networks, the Internet and the like. The system 100 can provide technical improvements to neural network systems by reducing computational loads on neural networks, reducing computational costs for neural networks, and/or improving quality of images generated by neural networks, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., conversion component 108, data enhancement component 110, and/or image generation component 112) to perform one or more actions. In one or more embodiments, memory 104 can store computer-executable components (e.g., conversion component 108, data enhancement component 110, and/or image generation component 112).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, conversion component 108 can receive sound waves reflected by structures in an environment detected by an imaging sonar and convert the sound waves to discrete tokens in natural language using a neural network model (e.g., a voice-to-text model), wherein the sound waves can be returned by a sound transmitter of the imaging sonar. Based on the discrete tokens, image generation component 112 can generate an image of an environment detected by the imaging sonar, using another neural network model (e.g., text-to-image model), wherein the discrete tokens can be non-semantic. Additional aspects of the one or more embodiments discussed herein are explained in greater detail with reference to subsequent figures. System 100 can be associated with, such as accessible via, a computing environment 1000 described below with reference to FIG. 10. For example, system 100 can be associated with a computing environment 1000 such that aspects of processing can be distributed between system 100 and the computing environment 1000.

In an embodiment, image generation component 112 can use a first neural network model to generate an image of an environment (e.g., image 116) detected by an imaging sonar, based on discrete tokens in natural language that can represent sound waves (e.g., sound waves 114) reflected by structures in the environment, wherein the discrete tokens can be non-semantic. For example, image generation component 112 can use a text-to-image neural network model that can process the discrete tokens and output image 116. The discrete tokens can be generated by conversion component 108 from the sound waves. For example, conversion component 108 can receive sound waves 114 from a sound transmitter of the imaging sonar, and conversion component 108 can use a second neural network (e.g., a voice-to-text neural network) to convert sound waves 114 to the discrete tokens. The discrete tokens can act as a bridge between the sound waves and the image of the environment and cause a computational load on at least the first neural network model to fall below a first defined threshold. In general, the discrete tokens can reduce a computational load on the first neural network model and the second neural network model. An absolute amount of computational load reduction can be different for each neural network model, but a reduction ratio for each neural network model can be similar, wherein the reduction ratio can be about 55%-70% of a total computing load.

Data enhancement component 110 can add one or more new tokens to a token sequence comprising the discrete tokens, wherein the one or more new tokens can respectively represent one or more features in the environment not captured by the imaging sonar. Data enhancement component 110 can employ token injection enhancement to add the one or more new tokens to the token sequence. Token injection enhancement can include, but is not limited to, random scrambling, back translation, etc. A purpose of token injection enhancement is to generate a large amount of simulation data. Addition of the one or more new tokens (e.g., discrete natural language tokens) to the token sequence can enable the one or more features to be included in the image of the environment. For example, since the one or more new tokens can respectively represent the one or more features, addition of the one or more new tokens to the token sequence can result in a new token sequence. The new token sequence can be an input to the first neural network that can generate an image comprising the one or more features corresponding to the one or more tokens. Using the discrete tokens to generate the image of the environment can enable the image of the environment to be generated with quality above a second defined threshold. Thus, various embodiments herein can simulatively convert information returned from sonar into human-understandable images for visually determining an object (e.g., a stone or a fish at a 10-mile distance, etc.)

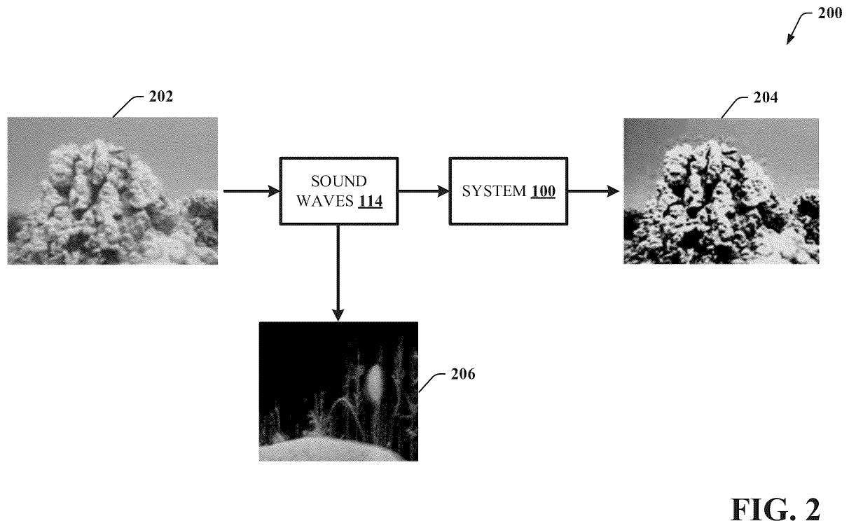

FIG. 2 illustrates a flow diagram of an example, non-limiting method 200 that can generate an image of an object using sound waves reflected by the object in accordance with one or more embodiments described herein. Repetitive description of like elements and/or processes employed in respective embodiments is omitted for sake of brevity.

One or more embodiments described herein can describe a sound wave-to-image technology that can use language tokens as bridging features. For example, a method to generate images from sound waves can convert the sound waves returned by a sound transmitter of an imaging sonar into discrete tokens in the form of language (discrete language tokens) by using a voice-to-language method and use the generated discrete language tokens to restore a corresponding image of a scene detected by the imaging sonar via the sound waves. For example, the sound waves can be processed by a neural network model to generate the discrete language tokens, wherein each token can represent a feature in the scene. The discrete language tokens can be non-semantic. For example, a non-semantic token list comprising discrete natural language tokens can be generated (e.g., by the neural network model). The discrete language tokens can be processed by another neural network converted to an image of the scene. The method can effectively reduce computational complexity of a model, since introduction of the discrete language tokens can reduce an amount of parameters to be processed by a neural network model for converting sound to an image. For example, if M can represent all sonic input possibilities associated with a sound wave and N can represent all image output possibilities for an object detected by the sound wave, a probability of mapping the information contained in the sound wave to the information contained in the image can be a product of M and N (i.e., M×N), which can be a large amount of data for a neural network to process, since M and N can generally be in the order of tens of millions. On the contrary, if a layer of discrete natural language tokens, T, can be introduced, a probability of mapping the information contained in the sound wave to the information contained in the image can be a product of M and T plus a product of T and M (i.e., M×T+T×M), which can be much less than M×N. That is because vocabulary in natural language can generally be in the order of thousands, whereas M and N can generally be in the order of tens of millions.

For example, at 202 of non-limiting method 200, a seabed reef can reflect sound waves 114 directed towards the seabed reef by an imaging sonar. The sound waves can be received by system 100, and system 100 can convert sound waves 114 to discrete natural language tokens. For example, conversion component 108 can use a voice-to-text model to convert sound waves 114 into discrete natural language tokens, wherein sound waves 114 can be an input to the voice-to-text model and the discrete natural language tokens can be an output of the voice-to-text model based on the input comprising sound waves 114. At 204, image generation component 112 can use a text-to-image model to generate an image of the seabed reef detected by the imaging sonar, based on the discrete natural language tokens, wherein the discrete natural language tokens can be an input to the text-to-image model and the image of the seabed reef can be an output of the text-to-image model based on the input comprising the discrete natural language tokens. The image generated at 204 by implementing one or more embodiments of the subject invention can be easy for a human entity to interpret, for example, as opposed to the graph illustrated at 206 that can represent seabed reefs and that can be generated without implementing the one or more embodiments herein, wherein such graphs can be difficult for non-professionals to identify. It is to be appreciated that the graph illustrated at 206 is only for purposes of comparison.

The method can also improve quality of a final image generated by the model through a low-cost data augmentation method. For example, system 100 (or components thereof) can use deconvolution, attention techniques, and/or heatmaps to discover respective contributions of individual tokens of the discrete natural language tokens to local features of the image of the seabed reef (e.g., discovering that a natural language token “feed” has made the greatest contribution to generation of coral features in the image). Deconvolution is a technique used in image processing and computer vision to reconstruct an input image from feature representations of the input image. Attention techniques, such as self-attention or transformer models, can be used to selectively focus on relevant parts of input or feature maps, for improving a model's performance. Heatmaps, often generated using techniques like Grad-CAM, can highlight important regions of an image that can contribute to a model's decision, providing interpretability and insights into the model's behavior. Based on the respective contributions of the individual tokens, data enhancement component 110 can add one or more of the individual tokens, via token injection enhancement, to a token sequence corresponding to the image of the seabed reef or another token sequence corresponding to another image to add one or more features to the image or the other image, wherein real data for the one or more features cannot be collected via sound waves. For example, adding the token “feed” to the token sequence for image of the seabed reef can include coral features to the image where the coral features cannot be collected via sound waves 114.

In general, using deconvolution, attention techniques, and heatmaps, one or more embodiments described herein can highlight a relationship between a token and an image. A pre-trained model can be trained to decide the relationship between the token and the image (e.g., which words can mean which image or feature) such that upon training, the pre-trained model can receive sound waves and convert the sound waves to natural language tokens representative of image features. During training of the neural network model, the neural network model can be used to find a regular pattern automatically and at a final stage of training, a relationship can be built between a word (token) and a feature. That is, a matching connection pattern can be built. Thereafter, heat maps can be used (e.g., by data enhancement component 110) to determine respective contributions of tokens assigned by the neural network model to individual features in an image.

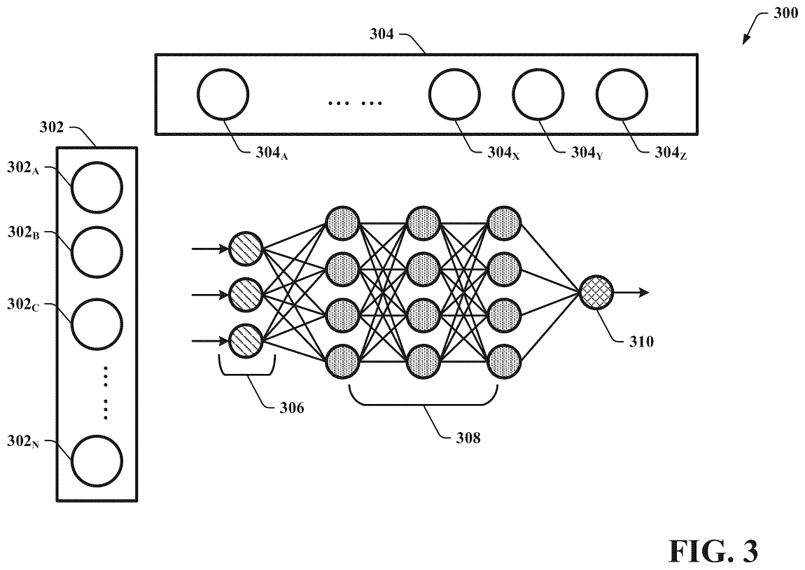

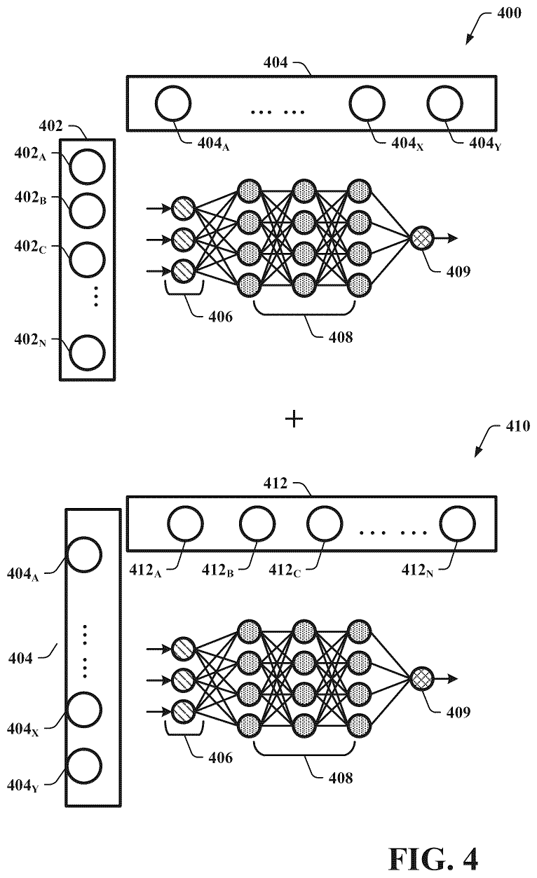

FIGS. 3 and 4 respectively illustrate example, non-limiting representations 300 and 400 of sonic input possibilities and image output possibilities for a neural network in accordance with one or more embodiments described herein. Repetitive description of like elements and/or processes employed in respective embodiments is omitted for sake of brevity.

One or more embodiments discussed herein can convert voice (i.e., sounds returned from a sound transmitter of an imaging sonar) to an image, using natural language tokens, that can highlight important information in the sound. As illustrated in FIG. 3, a probability of information based on information contained in a sound wave can be 302 (or M), wherein 302_{A}, 302_{B}, 302_{C}, . . . , 302_{N} can represent sonic input possibilities. Similarly, a probability of information based on information contained in an image can be 304 (or N), wherein 304_{A}, . . . , 304_{X}, 304_{Y}, 304_{Z} can represent image output possibilities. Then, a probability of mapping the information contained in the sound wave to the information contained in the image can be a product of M and N (i.e., M×N), which can be a large amount of data for a neural network to process (e.g., such as the neural network illustrated in FIG. 3 comprising input later 306, hidden layers 308 and output later 310). For example, for simplicity of explanation, if M=1000 and N=1000, then N×M=1000×1000. Similar considerations can apply to possibilities for training the neural network. As stated elsewhere herein, such large amounts of data can lead to problems of high computational costs and poor imaging effects.

One or more embodiments described herein can introduce a layer of discrete tokens as a bridge between continuous sound wave features and continuous image features by first converting the continuous sound wave features into token features, and then restoring an image from the token features. Selecting a token with a certain specification as a bridge can reduce parameters of an overall model and reduce an amount of computation. Further, selecting the token can lay a good foundation for data enhancement at a later stage. Since generating images from sounds can be based on connecting a large amount of sound features to a large amount of features, the sound features can be listed as words in the form of discrete natural language tokens, since words can represent small units of human language. As a result, a relatively smaller neural network (e.g., as compared to a neural network that does not rely on language tokens) can be built for mapping sounds to images.

For example, an original amount of information to be learnt by the neural network can be equal to a product of M and N (e.g., M×N). When a layer of discrete tokens, T, is introduced, a new amount of information to be learnt by the neural network can be equal to a product of M and T plus a product of T and M (i.e., M×T+T×M). Respective amounts of information of initial features of images (e.g., 304 or N) and sounds (e.g., 302 or M) can generally be in the order of tens of millions, and vocabulary in natural language can generally be in the order of thousands, T<<M and T<<N. Thus, the new amount of information is much less than the original amount of information, for example, as described by equation 1. Further, an amount of network parameters resulting from implementation of discrete tokens (e.g., as disclosed by one or more embodiments herein) can be much smaller than an amount of network parameters generated without implementation of discrete tokens.

M×T+T×M<<M×N Equation 1:

The concept of equation 1 can be more fully described with reference to FIG. 4, wherein 402_{A}, 402_{B}, 402_{C}, . . . , 402_{N} comprised in 402 (or M) can be sonic output possibilities, 404_{A}, . . . , 404_{X}, 404_{Y} comprised in 404 (or T) can represent a length of all token lists, and 412_{A}, 41_{2B}, 412_{C}, . . . 412_{N} comprised in 412 (or N) can be image output possibilities. At 400, FIG. 4 illustrates the product of M×T and at 410, FIG. 4 illustrates the product of T×M. A summation of both products can reduce a computational load on a neural network (e.g., such as the neural network illustrated in FIG. 4 comprising input later 406, hidden layers 408 and output later 409), for example, by disassembling a one-way calculation process for a model (e.g., wherein sound waves can be directly converted to images) into a two-step process by introducing natural language tokens. For example, introduction of the discrete tokens can reduce a computational load on a first neural network model and a second neural network model associated with the two-step process. An absolute amount of computational load reduction can be different for each neural network model, but a reduction ratio for each neural network model can be similar, wherein the reduction ratio can be about 55%-70% of a total computing load. As stated elsewhere herein, the natural language tokens can act as bridging features between the sound waves and the image, wherein data enhancement can be performed at the token level to obtain more simulation training data and improved quality of a final image generated.

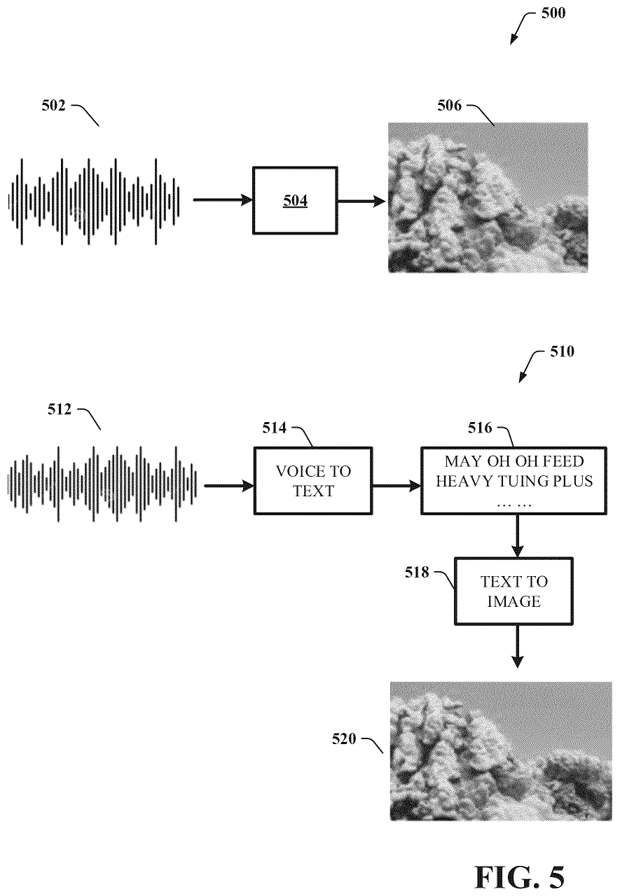

FIG. 5 illustrates flow diagrams of example, non-limiting methods 500 and 510 that can generate an image of an object from discrete natural language tokens generated from sound waves in accordance with one or more embodiments described herein. Repetitive description of like elements and/or processes employed in respective embodiments is omitted for sake of brevity.

At 502 of non-limiting method 500, sound waves received by a sound transmitter of an imaging sonar can be input to system 504. The sound waves can be representative of an object, an environment, or a scene detected by the imaging sonar. For example, as illustrated in FIG. 5, the sound waves can be representative of an underwater object or environment. The sound waves received by system 504 can be converted to discrete natural language tokens. For example, a neural network model (e.g., voice-to-text model) can be used to convert the sound waves into discrete natural language tokens, wherein the sound waves can be an input to the neural network model and the discrete natural language tokens can be an output of the neural network model based on the input comprising the sound waves. At 506, system 504 can generate an image of the object, the environment, or the scene, based on the discrete natural language tokens, wherein the discrete natural language tokens can be an input to another neural network model (e.g., a text-to-image model) and the image can be an output of the other neural network model based on the input comprising the discrete natural language tokens.

The concept discussed above can be elaborated with reference to non-limiting method 510. At 512 of non-limiting method 510, sound waves received by a sound transmitter of an imaging sonar can be input to a system (e.g., system 100). As described above, the sound waves can be representative of an object, an environment, or a scene detected by the imaging sonar. At 514, the sound waves can be received by system 100 (e.g., by conversion component 108) and at 516, the sound waves can be converted by system 100 (e.g., by conversion component 108) to discrete natural language tokens using a voice-to-text model, wherein the sound waves can be an input to the voice-to-text model and the discrete natural language tokens can be an output of the voice-to-text model based on the input comprising the sound waves. For example, a token sequence comprising the discrete natural language tokens can be “may oh oh feed heavy tuing plus . . . ” wherein individual tokens (e.g., may, heavy, plus, etc.) can represent features comprised in an environment. At 518, the discrete natural language tokens can be converted by system 100 (e.g., image generation component 112) to an image of the object, the environment, or the scene, using a text-to-image model, wherein the discrete natural language tokens can be an input to the text-to-image model and the image can be an output of the text-to-image model based on the input comprising the discrete natural language tokens. At 520, system 100 (e.g., image generation component 112) can generate the image.

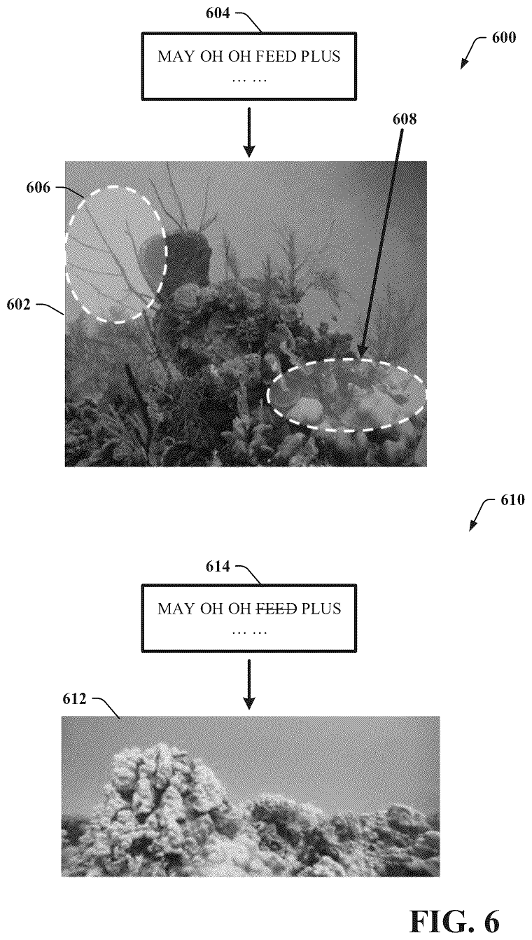

FIG. 6 illustrates flow diagrams 600 and 610 for example, non-limiting images generated from discrete natural language tokens in accordance with one or more embodiments described herein. Repetitive description of like elements and/or processes employed in respective embodiments is omitted for sake of brevity.

As stated elsewhere herein, a series of tokens can be chosen as a bridge between sound and an image to reduce training parameters and an amount of calculation for a neural network model that can generate the image from the sound. In the various embodiments herein, natural language can be chosen as a bridge token instead of randomly generating tokens similar to a universal unique identifier (UUID) type token that can be generated by a computer automatically. Natural language can be chosen as the bridge token because of availability of mature open-source pre-trained models (i.e., models with pre-training) for sound-to-language conversion (e.g., models that can convert voice from a recorded meeting to text). For example, a speech-to-word pre-trained model can be used in one or more embodiments discussed herein to convert sound waves to discrete natural language tokens. The pre-trained speech-to-word model can be trained for a specific speech-to-word task. Pre-trained models have knowledge based on their previous training, which can speed up a training process for the specific task and can make the trained model more accurate. Although, the discrete natural language tokens converted from the sound waves can be non-semantic, pre-trained models can provide very good initialization vectors (original vectors) for training.

Likewise, mature open-source pre-trained models for language-to-image conversion can be used for converting the discrete natural language tokens to the image. The initialization vectors provided by such models can greatly speed up a training speed of a model and are not easy to overfit. Further, natural language can be the easiest serialized token for humans to understand. Natural language can be most easily understood by humans, and it can also be relatively easy to find a regular pattern of tokens as compared to UUID. Thus, even without semantics, it can be relatively easy for labelers or annotators to find rules as opposed to random tokens. Using natural language as a bridge token can facilitate labelers or algorithm engineers to use tokens later. For example, a data scientist can perform data enhancements and data re-annotation.

For example, as illustrated at 600 in FIG. 6, sequence 604 can be “may oh oh feed plus . . . ” which can be used to generate (e.g., by image generation component 112 of FIG. 1) image 602, wherein sequence 604 can be a first portion of a natural language token sequence, and wherein image 602 can be an image of an underwater scene comprising corals, rocks, etc. Each token from sequence 604 can correspond to a feature from image 602. For example, as highlighted at 606, the token “feed” can represent a coral, and as highlighted at 608, the token “may” can represent a synaptic rock. Image 602 can be enhanced by performing data enhancement and data re-annotation (e.g., by data enhancement component 110 of FIG. 1), which can be valuable to the generation of a final image. For example, at 610, sequence 614 can be generated (e.g., by conversion component 108 of FIG. 1) from sequence 604 by removing the token “feed” (e.g., as indicated by the strikethrough in sequence 614) to generate image 612 (e.g., by image generation component 112). Image 612 can be a mock description of an underwater scene (e.g., created out of thin air) that does not have coral features as a result of removing the token “feed.”

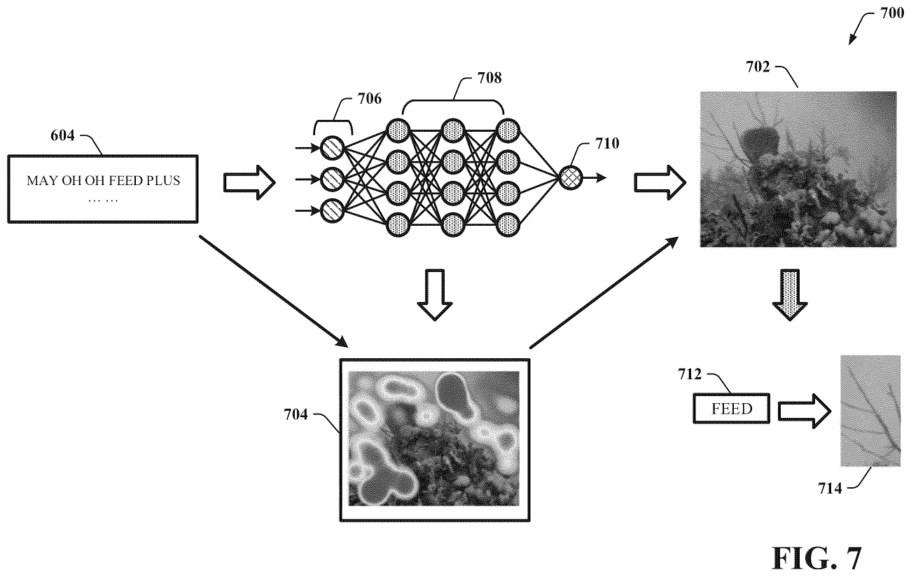

FIG. 7 illustrates a flow diagram of an example, non-limiting method 700 that can generate an image of an object from discrete natural language tokens using data augmentation in accordance with one or more embodiments described herein. Repetitive description of like elements and/or processes employed in respective embodiments is omitted for sake of brevity.

With continued reference to FIG. 6, in one or more embodiments, a first sentence of a token sequence composed of discrete natural language tokens can be “may oh oh feed plus . . . ” (e.g., sequence 604) which can result in an image of corals and reefs on the seafloor via language-to-image conversion method (e.g., using a text-to-image model). In various embodiments discussed herein, deconvolution, attention techniques, and heatmaps can be used to discover a contribution of each token to local features of a final image (e.g., image 602, image 612, etc.). As described elsewhere herein, deconvolution is a technique used in image processing and computer vision to reconstruct an input image from feature representations of the input image. Attention techniques, such as self-attention or transformer models, can be used to selectively focus on relevant parts of input or feature maps, for improving a model's performance. Heatmaps, often generated using techniques like Grad-CAM, can highlight important regions of an image that can contribute to a model's decision, providing interpretability and insights into the model's behavior.

As illustrated at 704 in FIG. 7, through the analysis of a feature map of a hidden layer of a language-to-image model (e.g., the neural network model illustrated in FIG. 7 and comprising input layer 706, hidden layers 708 and output later 710), it can be observed that the token “feed” (illustrated at 712) has made the greatest contribution (in other words, is highly relevant) to generation of coral features (illustrated at 714) in image 702. That is, the token “feed” can control whether there is a coral object in a legend or image. Thus, if images with corals need to be generated in other scenarios, but real data cannot be collected through sound waves, then the token “feed” can be added to a token sequence via a method of token injection enhancement for data enhancement. As stated elsewhere herein, token injection enhancement can include, but is not limited to, random scrambling, back translation, etc. A purpose of token injection enhancement is to generate a large amount of simulation data. Such data enhancement (e.g., by data enhancement component 110 of FIG. 1) can have a large effect on improving image quality. It is to be appreciated that objects in image 702 can be representative of a short sentence composed of multiple tokens versus just being at the token level. The example of the token “feed” has been used for simplicity of explanation.

As stated earlier, the feature map based on sequence 604 can be output by a hidden layer of the neural network model, and thermal mapping (as indicated by the shaded patches at 704) can be used to identify the contribution of the token “feed” or another token. A schematic diagram and attention techniques can also be used to observe effects of a single token on features of a generated image. The schematic diagram can show corresponding relationships between tokens and legends. For example, deleting a token “feed” in a token sequence “may oh oh feed plus” can cause corresponding changes in a legend.

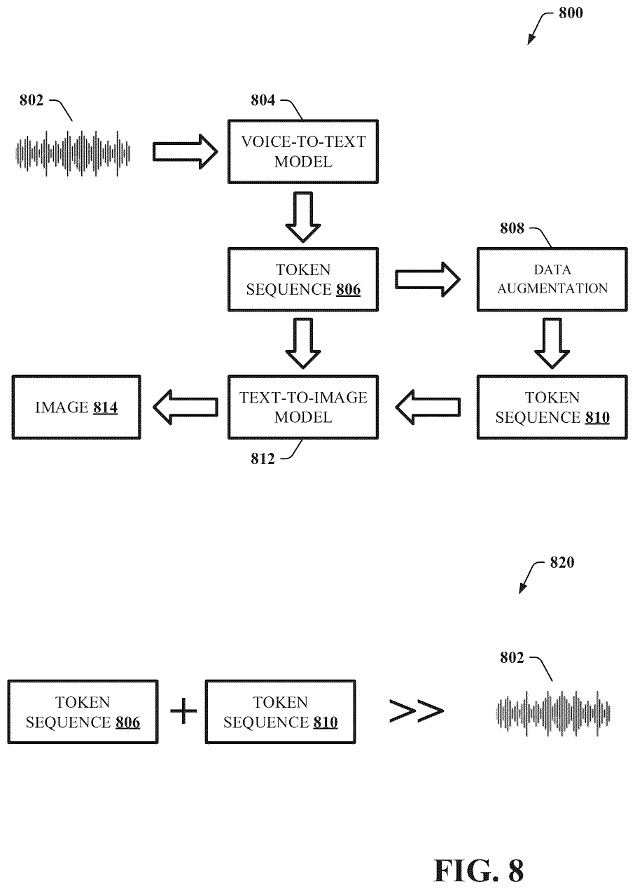

FIG. 8 illustrates a flow diagram of an example, non-limiting method 800 for generating an image from sound waves using discrete natural language tokens in accordance with one or more embodiments described herein. Repetitive description of like elements and/or processes employed in respective embodiments is omitted for sake of brevity.

As discussed in various embodiments herein, a sound-to-image model training process based on discrete natural language tokens can be used to first convert sound (e.g., sound waves) into a natural language token (e.g., by conversion component 108 of FIG. 1), and then use the natural language token to generate a final image (e.g., by image generation component 112 of FIG. 1) after data enhancement (e.g., by data enhancement component 110 of FIG. 1). Such a process can greatly reduce computational load of the model and a quality of the final images generated by members of a team implementing the one or more embodiments herein (e.g., by using a neural network model, system 100, image generation component 112 of system 100, etc.) can be improved through automatic data enhancement or artificial data enhancement.

At 802 in non-limiting method 800, sound waves received by a sound transmitter of an imaging sonar can be input to a voice-to-text model that can generate token sequence 806, wherein token sequence 806 can be composed of discrete natural language tokens. The voice-to-text model can be a foundation model that can be chosen from a list of open-source models. Token sequence 806 can be used for generating a token sequence 810, wherein token sequence 810 can be a simulation token sequence, via data augmentation. For example, at 808, data augmentation can be performed (e.g., by data enhancement component 110) on token sequence 806 to add one or more additional tokens to token sequence 806 to generate token sequence 810, in accordance with various embodiments described herein.

Token sequence 806 and token sequence 810 can be combined into one final token sequence to train a text-to-image model to generate an image from the sound waves, at 812. A pre-trained text-to-image model (e.g., foundation model) can be used as a base model for the training at 812, which can speed up a training process for training the text-to-image model. The text-to-image model can generate image 812 which can be a high-quality picture highlighting important features of an object, environment or scene detected by the imaging sonar via the sound waves. For example, image 812 can be an image of a stone at a distance, wherein image 812 may not capture colors of the stone, but image 812 can capture a shape of the stone (e.g., triangle, roll, ball, etc.). The discrete natural language tokens can act as a bridge between the sound waves and image 814 and cause a computational load involved in the process to fall below a first defined threshold. Using the discrete natural language tokens can also cause image 814 to be generated with quality above a second defined threshold.

As illustrated at 820, an amount of features in image 812 resulting from combining token sequence 810 and token sequence 806 can be much greater than an amount of sound wave features represented by the sound waves received at 802, for example, if an imaging sonar that generated the sound waves cannot capture certain features. As such, introducing discrete tokens as a bridge between sound waves and an image, as described by the one or more embodiments herein, can generate an image with better quality (e.g., a high-quality image) as compared to an image generated without introducing discrete tokens (e.g., a low-quality image), and data augmentation of the discrete tokens can further enhance the quality of the image.

Thus, various embodiments herein can disassemble a one-way calculation process for a model (e.g., wherein sound waves can be directly converted to images) by introducing natural language tokens, which can greatly reduce computational complexity of the model below a first defined threshold, as discussed in one or more embodiments herein. The sound waves can be bridged by the natural language tokens, and data enhancement can be performed on the natural language tokens based on identification of individual contributions of respective natural language tokens by using deconvolution, attention techniques and heatmaps, thereby obtaining more simulation training data and improving the quality of the final generated image.

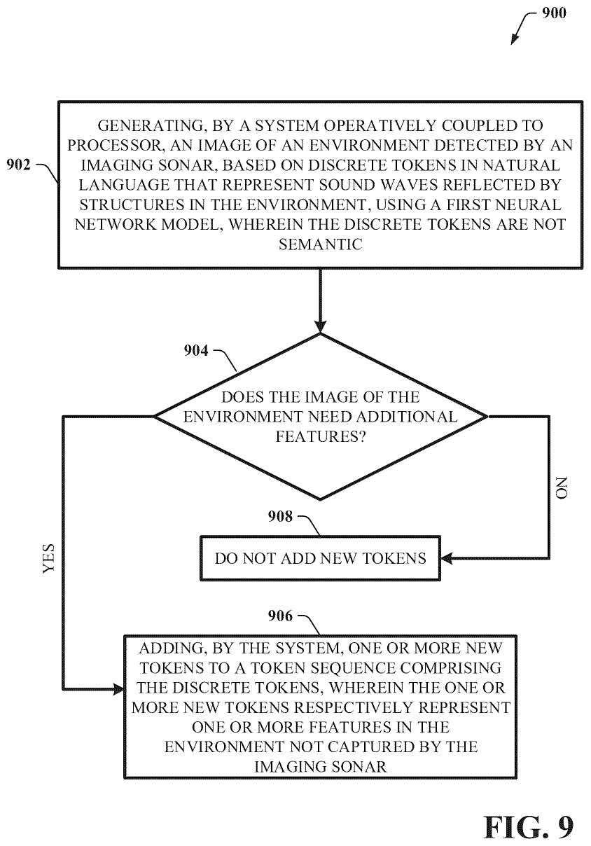

FIG. 9 illustrates a flow diagram of an example, non-limiting method 900 that can use discrete natural language tokens to generate an image from sound waves in accordance with one or more embodiments described herein. Repetitive description of like elements and/or processes employed in respective embodiments is omitted for sake of brevity.

At 902, the non-limiting method 900 can comprise generating (e.g., by image generation component 112), by a system operatively coupled to processor, an image of an environment detected by an imaging sonar, based on discrete tokens in natural language that represent sound waves reflected by structures in the environment, using a first neural network model, wherein the discrete tokens can be non-semantic.

At 904 in the non-limiting method 900 if it is determined that the image of the environment needs data enhancement via additional features (e.g., if some features were not captured by an imaging sonar), then at 906, the non-limiting method 900 can comprise adding (e.g., by data enhancement component 110), by the system, one or more new tokens to a token sequence comprising the discrete tokens, wherein the one or more new tokens respectively represent one or more features in the environment not captured by the imaging sonar.

If data enhancement via additional features is not needed, then at 908 of the non-limiting method 900, new tokens are not added to the token sequence.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively convert sound waves into discrete natural language tokens, generate an image using the discrete natural language tokens, as the one or more embodiments described herein can enable this process. And, neither can the human mind nor a human with pen and paper determine respective contributions of individual tokens to features in an image, as conducted by one or more embodiments described herein.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as discrete token-based image generation code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way. EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed:

1. A system, comprising:
a memory that stores computer-executable components; and
a processor that executes the computer-executable components stored in the memory, wherein the computer-executable components comprise:
an image generation component that uses a first neural network model to generate an image of an environment detected by an imaging sonar, based on discrete tokens in natural language that represent sound waves reflected by structures in the environment, wherein the discrete tokens are not semantic.

2. The system of claim 1, further comprising:
a conversion component that receives the sound waves from a sound transmitter and converts the sound waves to the discrete tokens using a second neural network model.

3. The system of claim 1, further comprising:
a data enhancement component that adds one or more new tokens to a token sequence comprising the discrete tokens, wherein the one or more new tokens respectively represent one or more features in the environment not captured by the imaging sonar.

4. The system of claim 3, wherein addition of the one or more new tokens to the token sequence enables the one or more features to be included in the image of the environment.

5. The system of claim 3, wherein the data enhancement component adds the one or more new tokens to the token sequence via token injection enhancement.

6. The system of claim 1, wherein the discrete tokens act as a bridge between the sound waves and the image of the environment and cause a computational load on at least the first neural network model to fall below a first defined threshold.

7. The system of claim 1, wherein using the discrete tokens to generate the image of the environment enables the image of the environment to be generated with quality above a second defined threshold.

8. A computer-implemented method, comprising:
generating, by a system operatively coupled to processor, an image of an environment detected by an imaging sonar, based on discrete tokens in natural language that represent sound waves reflected by structures in the environment, using a first neural network model, wherein the discrete tokens are not semantic.

9. The computer-implemented method of claim 8, further comprising:
receiving, by the system, the sound waves from a sound transmitter; and
converting, by the system, the sound waves to the discrete tokens using a second neural network model.

10. The computer-implemented method of claim 8, further comprising:
adding, by the system, one or more new tokens to a token sequence comprising the discrete tokens, wherein the one or more new tokens respectively represent one or more features in the environment not captured by the imaging sonar.

11. The computer-implemented method of claim 10, wherein addition of the one or more new tokens to the token sequence enables the one or more features to be included in the image of the environment.

12. The computer-implemented method of claim 10, wherein the one or more new tokens are added to the token sequence via token injection enhancement.

13. The computer-implemented method of claim 8, wherein the discrete tokens act as a bridge between the sound waves and the image of the environment and cause a computational load on at least the first neural network model to fall below a first defined threshold.

14. The computer-implemented method of claim 8, wherein using the discrete tokens to generate the image of the environment enables the image of the environment to be generated with quality above a second defined threshold.

15. A computer program product for improving a quality of images generated by an imaging sonar via discrete natural language tokens, the computer program product comprising a computer readable storage medium having program instructions embodied therewith, the program instructions executable by a processor to cause the processor to:
generate, by the processor, an image of an environment detected by the imaging sonar, based on discrete tokens in natural language that represent sound waves reflected by structures in the environment, using a first neural network model, wherein the discrete tokens are not semantic.

16. The computer program product of claim 15, wherein the program instructions are further executable by the processor to cause the processor to:
receive, by the processor, the sound waves from a sound transmitter; and
convert, by the processor, the sound waves to the discrete tokens using a second neural network model.

17. The computer program product of claim 15, wherein the program instructions are further executable by the processor to cause the processor to:
add, by the processor, one or more new tokens to a token sequence comprising the discrete tokens, wherein the one or more new tokens respectively represent one or more features in the environment not captured by the imaging sonar.

18. The computer program product of claim 17, wherein the one or more new tokens are added to the token sequence via token injection enhancement, and wherein addition of the one or more new tokens to the token sequence enables the one or more features to be included in the image of the environment.

19. The computer program product of claim 15, wherein the discrete tokens act as a bridge between the sound waves and the image of the environment and cause a computational load on at least the first neural network model to fall below a first defined threshold.

20. The computer program product of claim 15, wherein using the discrete tokens to generate the image of the environment enables the image of the environment to be generated with quality above a second defined threshold.
